(19) United States
(12) Patent Application Publication
(10) Pub. No.: US 2025/0274706 A1
(43) Pub. Date: Aug. 28, 2025

(54) IMAGING METHOD AND IMAGING APPARATUS

(71) Applicant: FUJIFILM Corporation, Tokyo (JP)

(72) Inventors: Kazuya OKIYAMA, Saitama-shi (JP); Mototada OTSURU, Saitama-shi (JP); Yukinori NISHIYAMA, Saitama-shi (JP)

(73) Assignee: FUJIFILM Corporation, Tokyo (JP)

(21) Appl. No.: 19/201,902

(22) Filed: May 7, 2025

Related U.S. Application Data
(63) Continuation of application No. PCT/JP2023/036435, filed on Oct. 5, 2023.

(30) Foreign Application Priority Data
Nov. 22, 2022 (JP) 2022-186834

(51) Int. Cl. H04R 3/00; G06F 3/16

(52) U.S. Cl. CPC H04R 3/005; G06F 3/162; H04R 2499/11

(57) ABSTRACT

An imaging method of the present disclosure includes an acquisition step of acquiring first sound data having a first number of bits, which is generated based on a sound signal output from a sound collection element and corresponds to video data obtained by imaging a subject, and a first creation step of creating second sound data having a second number of bits, which is larger than the first number of bits, based on the first sound data.

### CROSS-REFERENCE TO RELATED APPLICATIONS

This application is a continuation application of International Application No. PCT/JP2023/036435, filed Oct. 5, 2023, the disclosure of which is incorporated herein by reference in its entirety. Further, this application claims priority from Japanese Patent Application No. 2022-186834, filed on Nov. 22, 2022, the disclosure of which is incorporated herein by reference in its entirety.

### BACKGROUND

### 1. Technical Field

The technique of the present disclosure relates to an imaging method and an imaging apparatus.

### 2. Description of the Related Art

JP2012-073435A discloses an audio signal conversion device that samples an input analog audio signal of an L channel and an R channel with a sampling frequency of 192 kHz and a quantization bit rate of 24 bits in an A/D conversion device to generate a digital signal. A signal processing device is connected to an output side of the A/D conversion device. This signal processing device performs processing of down-sampling the frequency to ¼ (48 kHz) and processing of converting the down-sampled signal into a floating point format of a quantization bit rate of 32 bits.

JP2002-246913A discloses a data processing device that converts input data from a fixed point format to a floating point format by a conversion unit.

### SUMMARY

An object of one embodiment according to the technique of the present disclosure is to provide an imaging method and an imaging apparatus capable of improving quality of sound data.

In order to achieve the above object, an imaging method of the present disclosure comprises an acquisition step of acquiring first sound data having a first number of bits, which is generated based on a sound signal output from a sound collection element and corresponds to video data obtained by imaging a subject, and a first creation step of creating second sound data having a second number of bits, which is larger than the first number of bits, based on the first sound data.

It is preferable that the video data is moving image data.

It is preferable that the imaging method further comprises a second creation step of creating third sound data having a third number of bits, which is smaller than the second number of bits, based on the second sound data, and a third creation step of creating a first video file including the video data and the third sound data.

It is preferable that, in the second creation step, data of a volume range having a width of the third number of bits is extracted to create the third sound data, based on the second sound data.

It is preferable that the imaging method further comprises a setting step of setting the volume range for the second sound data for each predetermined time before the second creation step is executed.

It is preferable that, in the setting step, the volume range is set based on a feature of the video data or an imaging condition.

It is preferable that, in the setting step, the volume range is set based on a feature of a main subject appearing in a frame constituting the video data.

It is preferable that, in the setting step, the main subject is selected from a plurality of subjects appearing in the frame, based on a size or a type of the subject in the frame, a position of the subject within an angle of view, a focusing position of an imaging lens that images the subject, input information of a user, or visual line information of the user.

It is preferable that, in the first creation step, the first sound data generated by performing first gain processing on the sound signal is combined with the first sound data generated by performing second gain processing, which has a different gain amount from the first gain processing, on the sound signal, to create the second sound data.

It is preferable that the second sound data is in a floating point format.

It is preferable that a first mode of creating the first video file and a second mode of creating a second video file including the video data and the second sound data are included, the imaging method further comprising a step of recommending an execution of the second mode or a step of executing the second mode, based on volume information of the sound signal output from the sound collection element or volume information determined from a feature of the video data.

It is preferable that the imaging method further comprises a gain adjustment step of performing gain processing on the sound signal, in which, in the gain adjustment step, a gain amount of the gain processing is changed, based on volume information of a sound collected by the sound collection element, volume information determined from a feature of the subject, or priority information of a sound source to be recorded.

An imaging apparatus of the present disclosure comprises an imaging element that images a subject to generate video data, and a processor configured to acquire first sound data having a first number of bits, which is generated based on a sound signal output from a sound collection element and corresponds to the video data, and create second sound data having a second number of bits, which is larger than the first number of bits, based on the first sound data.

It is preferable that the imaging apparatus further comprises a housing that accommodates the imaging element and the processor, and a connecting part that connects an external microphone including the sound collection element to the housing.

It is preferable that the sound signal is converted into a digital signal inside the external microphone and then transmitted into the housing via the connecting part.

### BRIEF DESCRIPTION OF THE DRAWINGS

Exemplary embodiments according to the technique of the present disclosure will be described in detail based on the following figures, wherein:

FIG. 1 is a diagram showing an example of a configuration of an imaging apparatus,

FIG. 2 is a diagram showing an example of a configuration of a sound signal processing circuit,

FIG. 3 is a diagram conceptually showing sound signal processing by the sound signal processing circuit,

FIG. 4 is a diagram showing an example of a functional configuration of a processor,

FIG. 5 is a diagram conceptually showing combination processing and data format conversion processing,

FIG. 6 is a diagram conceptually showing feature extraction processing and volume range setting processing,

FIG. 7 is a diagram conceptually showing data extraction processing,

FIG. 8 is a flowchart showing an example of an operation of the imaging apparatus,

FIG. 9 is a flowchart showing an example of a mode setting step according to a third modification example,

FIG. 10 is a flowchart showing an example of a gain adjustment step according to a fourth modification example, and

FIG. 11 is a diagram showing a configuration of the imaging apparatus according to a fifth modification example.

### DETAILED DESCRIPTION

An example of an embodiment according to the technique of the present disclosure will be described with reference to accompanying drawings.

First, terms used in the following description will be described.

In the following description, “AF” is an abbreviation for “auto focus”. “MF” is an abbreviation for “manual focus”. “IC” is an abbreviation for “integrated circuit”. “CPU” is an abbreviation for “central processing unit”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”. “ADC” is an abbreviation for “analog to digital converter”. “LPCM” is an abbreviation for “linear pulse code modulation”.

As an embodiment of an imaging apparatus, the technique of the present disclosure will be described by using a lens-interchangeable digital camera as an example. The technique of the present disclosure is not limited to the lens-interchangeable type, and can be employed for a lens-integrated digital camera.

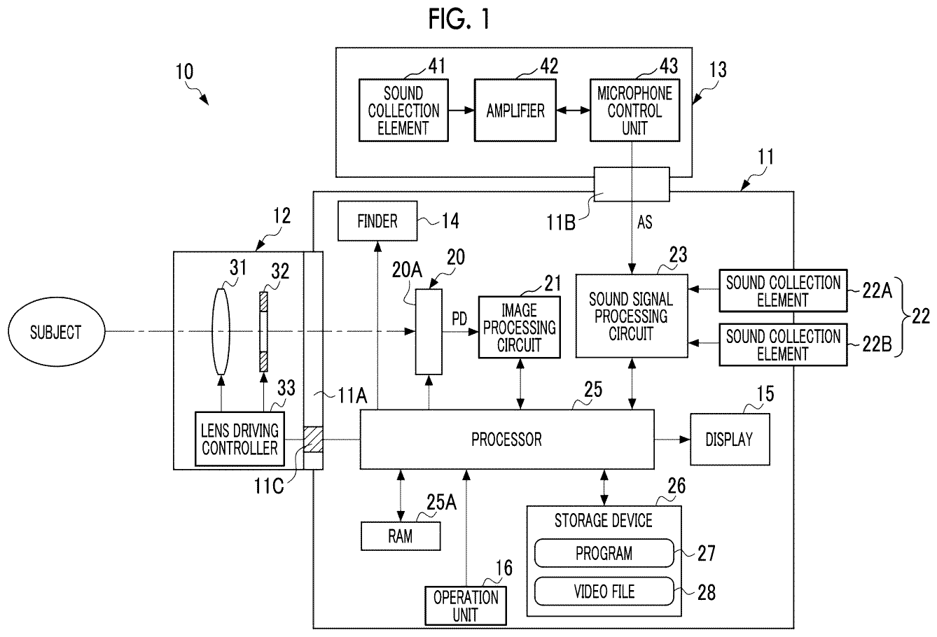

FIG. 1 shows an example of a configuration of an imaging apparatus 10. The imaging apparatus 10 is the lens-interchangeable digital camera. The imaging apparatus 10 is configured of a housing 11 and an imaging lens 12 that is interchangeably mounted on the housing 11 and includes a focus lens 31. The imaging lens 12 is attached to a front surface side of the housing 11 via a mount 11A.

Further, an external microphone 13 can be attachably and detachably attached to the housing 11. The external microphone 13 is attached to the housing 11 via a connecting part 11B provided on an upper surface of the housing 11. The external microphone 13 is a gun microphone, a zoom microphone, or the like. The connecting part 11B is, for example, a hot shoe.

The housing 11 is provided with an operation unit 16 including a dial, a release button, and the like. Examples of an operation mode of the imaging apparatus 10 include a still image capturing mode, a video capturing mode, and an image display mode. The operation unit 16 is operated by a user in a case where the operation mode is set. Further, the operation unit 16 is operated by the user in a case where execution of still image capturing or video capturing is started.

Further, the operation unit 16 is operated by the user in a case where a focusing mode is selected. The focusing mode includes an AF mode and an MF mode. In the AF mode, a subject area selected by the user or a subject area automatically detected by the imaging apparatus 10 is set as a focus detection area (hereinafter referred to as AF area) to perform focusing control. In the MF mode, the user operates a focus ring (not shown) to manually perform the focusing control.

Further, the housing 11 is provided with a finder 14. For example, the finder 14 is a hybrid finder (registered trademark). The hybrid finder refers to, for example, a finder in which an optical view finder (hereinafter referred to as “OVF”) and an electronic view finder (hereinafter referred to as “EVF”) are selectively used. The user can observe an optical image or live view image of a subject projected onto the finder 14 via a finder eyepiece portion (not shown).

Further, a display 15 is provided on a rear surface side of the housing 11. The display 15 displays an image based on video data PD obtained by imaging, various menu screens, and the like. The user can also observe the live view image projected onto the display 15, instead of the finder 14.

The housing 11 is electrically connected to the imaging lens 12 via an electrical contact 11C provided on the mount 11A.

The imaging lens 12 includes a focus lens 31, a stop 32, and a lens driving controller 33. The lens driving controller 33 is electrically connected to a processor 25 accommodated in the housing 11, via the electrical contact 11C.

The lens driving controller 33 drives the focus lens 31 and the stop 32, based on control signals transmitted from the processor 25. The lens driving controller 33 performs drive control of the focus lens 31, based on the control signal for the focusing control that is transmitted from the processor 25, in order to adjust a position of the focus lens 31.

The stop 32 has an opening with a variable opening diameter. The lens driving controller 33 performs drive control of the stop 32, based on the control signal for stop adjustment that is transmitted from the processor 25, in order to adjust an amount of light incident on an imaging sensor 20.

Further, the imaging sensor 20, an image processing circuit 21, a built-in microphone 22, a sound signal processing circuit 23, the processor 25, and a storage device 26 are provided inside the housing 11. The processor 25 controls operations of the imaging sensor 20, the image processing circuit 21, the built-in microphone 22, the sound signal processing circuit 23, the storage device 26, and the display 15.

The processor 25 is configured of, for example, a CPU. The processor 25 is connected to a RAM 25A, which is a memory for primary storage. The storage device 26 is configured of, for example, a non-volatile memory such as a flash memory. The processor 25 executes various types of processing based on a program 27 stored in the storage device 26. The processor 25 may be configured of an assembly of a plurality of IC chips. Further, for example, the storage device 26 stores a video file 28 generated as a result of an imaging operation executed by the imaging apparatus 10.

The imaging sensor 20 is, for example, a CMOS-type image sensor. Light (subject image) that has passed through the imaging lens 12 is incident on a light-receiving surface 20A of the imaging sensor 20. A plurality of pixels that generate imaging signals through photoelectric conversion are formed on the light-receiving surface 20A. The imaging sensor 20 performs the photoelectric conversion on light incident on each pixel to generate and output the video data PD. The imaging sensor 20 is an example of “imaging element” according to the technique of the present disclosure.

The image processing circuit 21 performs, on the video data PD output from the imaging sensor 20, image processing including white balance correction, gamma correction processing, and the like.

The built-in microphone 22 is a stereo microphone including a pair of sound collection elements 22A and 22B. The sound collection elements 22A and 22B are sound sensors for a left side channel (hereinafter referred to as L channel) and a right side channel (hereinafter referred to as R channel). The sound collection elements 22A and 22B are sound sensors of an electrostatic type, a piezoelectric type, an electrodynamic type, or the like, and output collected sounds as sound signals. The sound signal processing circuit 23 performs, on the sound signals output from the sound collection elements 22A and 22B, sound signal processing including gain processing, A/D conversion processing, and the like.

The external microphone 13 includes a sound collection element 41, an amplifier 42, and a microphone control unit 43. In the present embodiment, the external microphone 13 is a mono microphone having one sound collection element 41. The sound collection element 41 is a sound sensor of an electrostatic type, a piezoelectric type, an electrodynamic type, or the like, and outputs a collected sound as the sound signal. The amplifier 42 performs the gain processing on the sound signal output from the sound collection element 41. The microphone control unit 43 controls a gain amount of the gain processing by the amplifier 42.

Further, the microphone control unit 43 supplies the sound signal subjected to the gain processing by the amplifier 42 to the sound signal processing circuit 23 in the housing 11 via the connecting part 11B. A mono and analog sound signal AS is supplied from the external microphone 13 to the sound signal processing circuit 23. The processor 25 controls the operation of the microphone control unit 43.

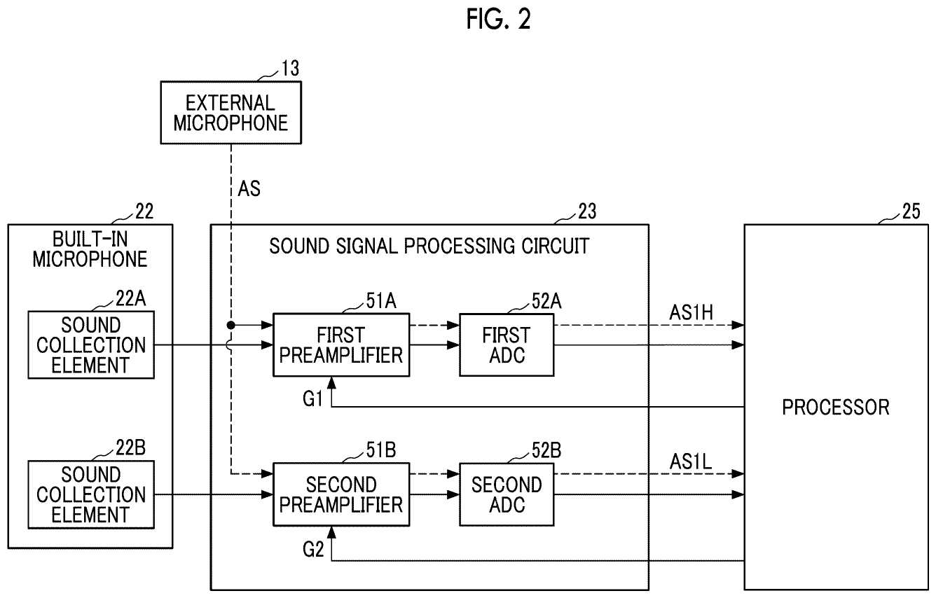

FIG. 2 shows an example of a configuration of the sound signal processing circuit 23. The sound signal processing circuit 23 includes a first preamplifier 51A, a first ADC 52A, a second preamplifier 51B, and a second ADC 52B.

The first preamplifier 51A and the first ADC 52A are processing units for L-channel that perform the gain processing and the A/D conversion processing on the sound signal output from the sound collection element 22A included in the built-in microphone 22. The second preamplifier 51B and the second ADC 52B are processing units for R-channel that perform the gain processing and the A/D conversion processing on the sound signal output from the sound collection element 22B included in the built-in microphone 22.

In the first preamplifier 51A, the processor 25 controls a gain amount G1. In the second preamplifier 51B, the processor 25 controls a gain amount G2. In a case where the sound signal output from the built-in microphone 22 is subjected to the gain processing, the processor 25 sets the gain amounts G1 and G2 to the same value. The first ADC 52A and the second ADC 52B perform sampling with, for example, a quantization bit rate of 24 bits to convert an analog sound signal into a digital signal of a 24-bit LPCM format. The above is an example of a pulse code modulation format.

In a case where the external microphone 13 is connected to the connecting part 11B, the sound signal AS output from the external microphone 13 is input to the sound signal processing circuit 23. In this case, the operation of the built-in microphone 22 is invalidated, and the sound signal is not input from the built-in microphone 22 to the sound signal processing circuit 23.

The sound signal AS output from the external microphone 13 is input to the first preamplifier 51A and the second preamplifier 51B. The first preamplifier 51A performs the gain processing on the sound signal AS with the gain amount G1. The second preamplifier 51B performs the gain processing on the sound signal AS with the gain amount G2. In a case where the gain processing is performed on the sound signal AS output from the external microphone 13, the processor 25 sets the gain amount G1 and the gain amount G2 to different values. Hereinafter, the gain processing performed by the first preamplifier 51A is referred to as first gain processing, and the gain processing performed by the second preamplifier 51B is referred to as second gain processing.

The first ADC 52A converts the sound signal AS subjected to the first gain processing by the first preamplifier 51A into the digital signal. The second ADC 52B converts the sound signal AS subjected to the second gain processing by the second preamplifier 51B into the digital signal. Hereinafter, the sound signal AS digitized by the first ADC 52A is referred to as first sound data AS1H, and the sound signal AS digitized by the second ADC 52B is referred to as first sound data AS1L. The first sound data AS1H and AS1L are output from the sound signal processing circuit 23 to the processor 25.

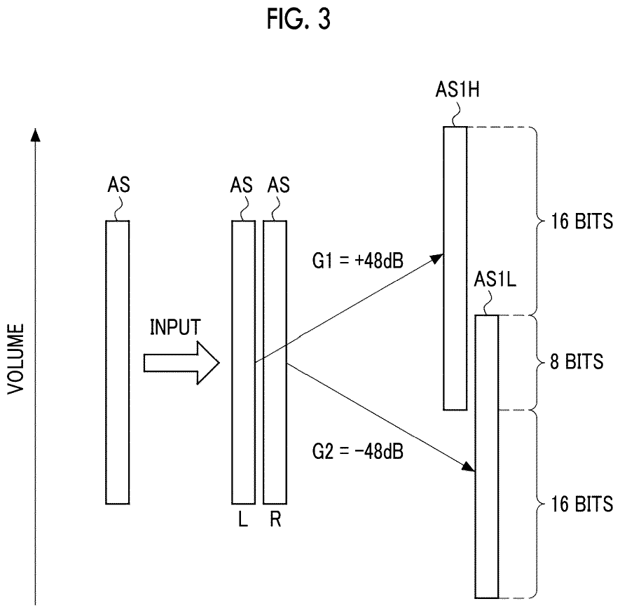

FIG. 3 conceptually shows the sound signal processing by the sound signal processing circuit 23. The sound signal AS output from the external microphone 13 is input to the processing unit for L-channel and the processing unit for R-channel. The sound signal AS input to the processing unit for L-channel is subjected to the first gain processing with the gain amount G1, then is converted into the digital signal, and thus, is output from the sound signal processing circuit 23 as the first sound data AS1H. The sound signal AS input to the processing unit for R-channel is subjected to the second gain processing by the gain amount G2, then is converted into the digital signal, and thus, is output from the sound signal processing circuit 23 as the first sound data AS1L. In the present embodiment, the number of bits (hereinafter referred to as first number of bits) of the first sound data AS1H and AS1L is 24 bits.

For example, the gain amount G1 is assumed to be +48 dB, and the gain amount G2 is assumed to be −48 dB. Since 48 dB corresponds to a volume width of 8 bits, there is a deviation of 16 bits between the first sound data AS1H of high gain and the first sound data AS1L of low gain, as shown in FIG. 3. In other words, the first sound data AS1H overlaps with the first sound data AS1L by 8 bits.

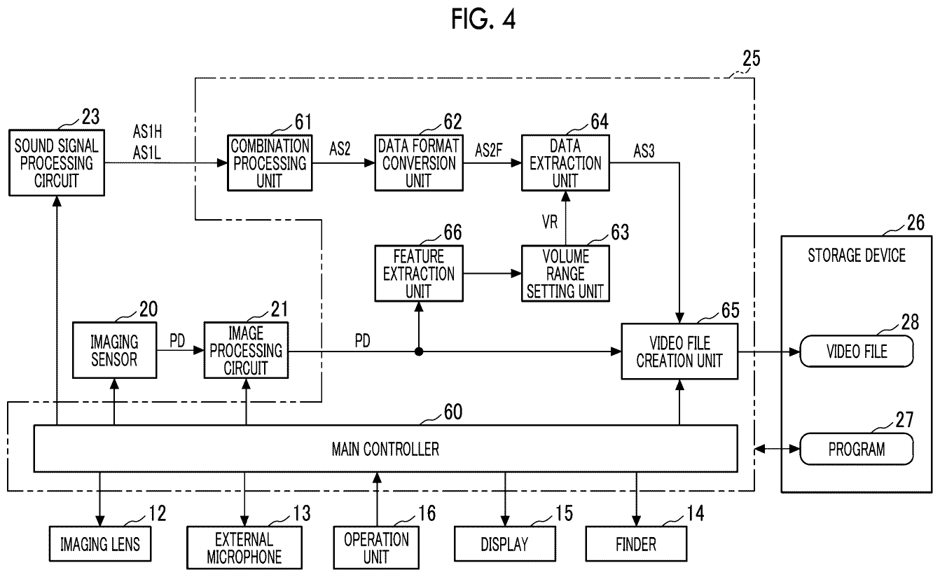

FIG. 4 shows an example of a functional configuration of the processor 25. The processor 25 executes the processing according to the program 27, which is stored in the storage device 26, to implement various functional units. Various functional units shown in FIG. 4 are implemented in the video capturing mode. As shown in FIG. 4, for example, a main controller 60, a combination processing unit 61, a data format conversion unit 62, a volume range setting unit 63, a data extraction unit 64, a video file creation unit 65, and a feature extraction unit 66 are implemented in the processor 25.

The main controller 60 integrally controls each unit of the imaging apparatus 10. The main controller 60 controls the operation of the imaging apparatus 10 based on an instruction signal input from the operation unit 16. The main controller 60 controls the imaging sensor 20 to cause the imaging sensor 20 to perform the imaging operation. The imaging sensor 20 outputs the video data PD, which is generated by performing the imaging via the imaging lens 12. In the video capturing mode, the imaging sensor 20 outputs the video data PD for each frame cycle. The video data PD output from the imaging sensor 20 is subjected to the image processing by the image processing circuit 21 and then input to the processor 25. In a case of the video capturing mode, the video data PD is moving image data consisting of a plurality of frames.

Further, in the video capturing mode, in a case where the external microphone 13 is connected to the connecting part 11B, the main controller 60 controls the external microphone 13 to perform a sound collection operation. The external microphone 13 outputs the sound signal AS to the sound signal processing circuit 23 via the connecting part 11B while the imaging sensor 20 performs the imaging operation. The sound signal processing circuit 23 performs the above sound signal processing to output the first sound data AS1H and AS1L having the first number of bits. That is, the first sound data AS1H and AS1L correspond to the video data PD obtained by the imaging sensor 20 imaging the subject.

The combination processing unit 61 acquires the first sound data AS1H and AS1L output from the sound signal processing circuit 23 and combines the first sound data AS1H and AS1L to create second sound data AS2 having a second number of bits, which is larger than the first number of bits. The second sound data AS2 is digital data of the LPCM format.

The data format conversion unit 62 converts a data format of the second sound data AS2 into a floating point format. Hereinafter, the second sound data AS2 converted into the floating point format is referred to as second sound data AS2F.

The volume range setting unit 63 sets a volume range VR having a width of a third number of bits, which is smaller than the second number of bits, for a dynamic range of the second sound data AS2F. In the present embodiment, the volume range setting unit 63 sets the volume range VR based on a feature extracted by the feature extraction unit 66. The feature extraction unit 66 calculates a brightness value of a video based on, for example, the video data PD, and supplies the calculated brightness value to the volume range setting unit 63 as a feature of the video data PD.

The data extraction unit 64 extracts data of the volume range VR set by the volume range setting unit 63, based on the second sound data AS2F, to create third sound data AS3 having the third number of bits. The third sound data AS3 is digital data of the LPCM format.

The video file creation unit 65 creates the video file 28 including the video data PD output from the image processing circuit 21 and the third sound data AS3 corresponding to the video data PD, and stores the created video file 28 in the storage device 26. The video file 28 corresponds to “first video file” according to the technique of the present disclosure.

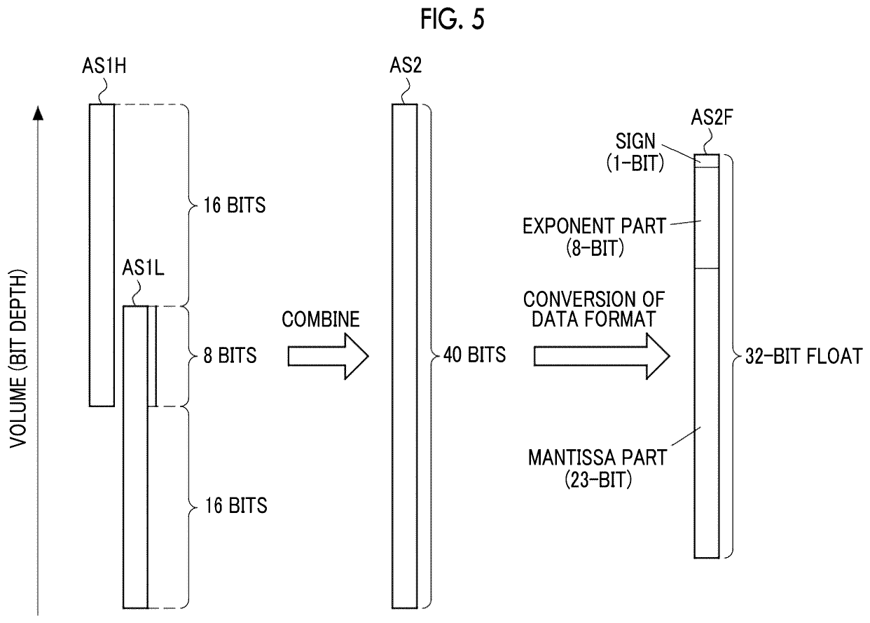

FIG. 5 conceptually shows combination processing by the combination processing unit 61 and data format conversion processing by the data format conversion unit 62. The combination processing unit 61 performs the mixing process on the overlap portion of 8 bits between the first sound data AS1H and AS1L to combine the first sound data AS1H and the first sound data AS1L. The number of bits (that is, the second number of bits) of the second sound data AS2, which is generated by the combination processing, is 40 bits. In this manner, with the combination of the first sound data AS1H and AS1L having different gain amounts, it is possible to obtain the second sound data AS2 with an expanded volume dynamic range.

The data format conversion unit 62 converts the second sound data AS2 of a 40-bit fixed point format into the second sound data AS2F of a 32-bit floating point format (so-called 32-bit float). The 32-bit float is configured of a 1-bit sign, an 8-bit exponent part, and a 23-bit mantissa part. A known method can be used for the conversion from the fixed point format to the floating point format. In the floating point format, a wide range of numerical values can be expressed.

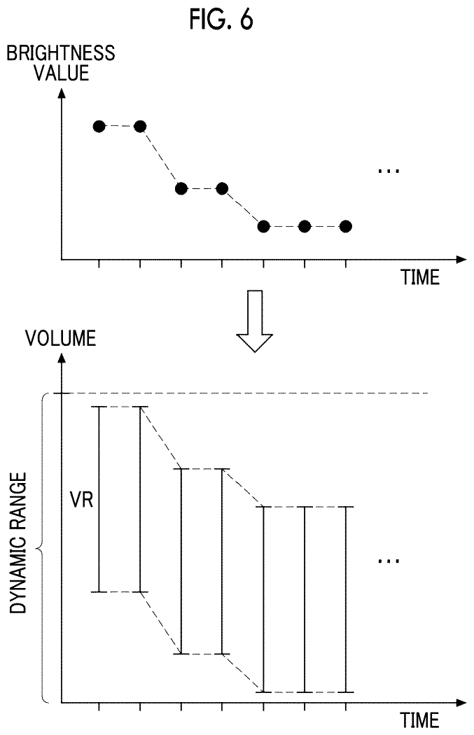

FIG. 6 conceptually shows feature extraction processing by the feature extraction unit 66 and volume range setting processing by the volume range setting unit 63. The feature extraction unit 66 calculates the brightness value for each predetermined time based on the video data PD, and supplies the calculated brightness value to the volume range setting unit 63 as the feature of the video data PD. The volume range setting unit 63 sets the volume range VR for each predetermined time, based on the brightness value supplied from the feature extraction unit 66 for each predetermined time. For example, the number of bits representing the width of the volume range VR (that is, the number of third bits) is 24 bits.

In the example shown in FIG. 6, the volume range setting unit 63 sets the volume range VR to a high volume side as the brightness value is larger, and sets the volume range VR to a low volume side as the brightness value is smaller. For example, the feature extraction unit 66 calculates the brightness value for each frame cycle, and the volume range setting unit 63 sets the volume range VR for each frame cycle. A time interval at which the feature extraction unit 66 calculates the brightness value and a time interval at which the volume range setting unit 63 sets the volume range VR may not be constant.

Since a situation in which the brightness value is large is assumed to be a noisy daytime environment and a volume level of the sound originating from the subject is assumed to be high in the situation, the volume range VR is set to the high volume side. On the other hand, since a situation in which the brightness value is small is assumed to be a quiet nighttime environment and the volume level of the sound originating from the subject is assumed to be low in the situation, the volume range VR is set to the low volume side. In this manner, with the setting of the volume range VR in accordance with the volume level of the sound originating from the subject, it is possible to appropriately extract the sound originating from the subject.

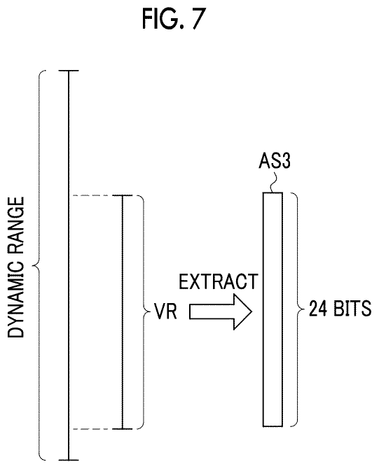

FIG. 7 conceptually shows data extraction processing by the data extraction unit 64. The data extraction unit 64 extracts the data of the volume range VR, based on the second sound data AS2F, to create the third sound data AS3 of a 24-bit fixed point format. Specifically, the data extraction unit 64 selects values of the sign and the exponent part of the 32-bit float according to the volume range VR to create the third sound data AS3 of 24 bits represented by the mantissa part.

In general, since the sound data included in a video file is the digital data of the 24-bit LPCM format, the third sound data AS3 of 24 bits is created in the present embodiment.

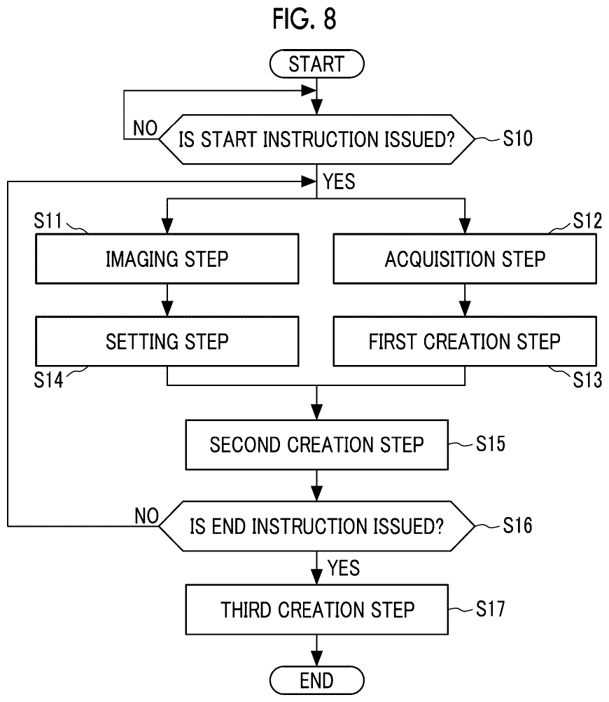

FIG. 8 is a flowchart showing an example of an operation of the imaging apparatus 10. FIG. 8 shows an operation in a case where the video capturing mode is selected as the operation mode and the external microphone 13 is connected to the connecting part 11B.

First, the main controller 60 determines whether or not the user issues a start instruction for the video capturing (step S10). In a case where the start instruction is determined to be issued (YES in step S10), an imaging step (step S11) and an acquisition step (step S12) are executed in parallel. In the imaging step, the imaging sensor 20 images the subject to generate the video data PD. In the acquisition step, the sound collection element 41 of the external microphone 13 collects the sound to acquire the first sound data AS1H and AS1L having the first number of bits corresponding to the video data PD. In the present embodiment, the sound signal processing circuit 23 performs the gain processing on the sound signal, which is output from the sound collection element 41, with different gain amounts and then performs an A/D conversion to generate the first sound data AS1H and AS1L.

After the acquisition step, a first creation step is executed (step S13). In the first creation step, the combination processing unit 61 creates the second sound data AS2 having the second number of bits, which is larger than the first number of bits, based on the first sound data AS1H and AS1L. Further, in the first creation step, the data format conversion unit 62 converts the second sound data AS2 into the second sound data AS2F of the floating point format.

After the imaging step, a setting step is executed (step S14). In the setting step, the volume range setting unit 63 sets the volume range VR having the width of the third number of bits for the second sound data AS2F. Specifically, the volume range VR is set based on the feature (brightness value in the present embodiment) of the video data PD extracted by the feature extraction unit 66.

After the first creation step and the setting step, a second creation step is executed (step S15). In the second creation step, the data extraction unit 64 creates the third sound data AS3 having the third number of bits based on the second sound data AS2F. Specifically, the data of the volume range VR is extracted, based on the second sound data AS2F, to create the third sound data AS3.

After the second creation step, the main controller 60 determines whether or not the user issues an end instruction for the video capturing (step S16). In a case where the end instruction is determined to be not issued (NO in step S16), the processing returns to steps S11 and S12. Steps S11 to S15 are repeatedly executed until the end instruction is determined to be issued in step S16.

In a case where the end instruction is determined to be issued (YES in step S16), a third creation step is executed (step S17). In the third creation step, the video file 28 including the video data PD and the third sound data AS3 is created by the video file creation unit 65 and stored in the storage device 26. The operation of the imaging apparatus 10 is ended as described above.

In the example shown in FIG. 8, the second creation step is executed during the video capturing, but may be executed after the video capturing is ended. In this case, the second sound data AS2F and a set value of the volume range VR, which are created during the video capturing, are stored in the RAM 25A. The data extraction unit 64 may read out, from the RAM 25A, the second sound data AS2F and the set value of the volume range VR to create the third sound data AS3 after the video capturing is ended.

As described above, an imaging method of the present disclosure includes an acquisition step of acquiring the first sound data having the first number of bits, which is generated based on the sound signal output from the sound collection element and corresponds to the video data obtained by imaging the subject, and the first creation step of creating the second sound data having the second number of bits, which is larger than the first number of bits, based on the first sound data. Accordingly, it is possible to improve quality of the sound data corresponding to the video data.

Hereinafter, various modification examples of the above embodiment will be described.

### First Modification Example

In the above embodiment, the feature extraction unit 66 extracts the brightness value as the feature of the video data PD, but may extract the feature of a main subject appearing in a frame constituting the video data PD. The main subject is a subject that is determined, by the user or the main controller 60, to be a subject having high importance among a plurality of subjects appearing in the frame. In the present modification example, the volume range setting unit 63 sets the volume range VR based on the feature of the main subject.

The feature of the main subject extracted by the feature extraction unit 66 is, for example, a type of the main subject. In this case, the volume range setting unit 63 sets the volume range VR based on the type of the main subject. For example, in a case where the type of the main subject is a type in which a generated sound is assumed to be high in volume, such as “airplane”, the volume range setting unit 63 sets the volume range VR to the high volume side. On the other hand, in a case where the type of the main subject is a type in which a generated sound is assumed to be low in volume, such as “person”, the volume range setting unit 63 sets the volume range VR to the low volume side.

As processing of selecting the main subject from the plurality of subjects appearing in the frame by the feature extraction unit 66, various types of processing can be employed. As an example, the feature extraction unit 66 selects the main subject based on sizes of the plurality of subjects appearing in the frame. In this case, the feature extraction unit 66 selects, as the main subject, the subject having the largest size among the plurality of subjects.

Further, the feature extraction unit 66 can also select the main subject based on types of the plurality of subjects appearing in the frame. In this case, for example, the feature extraction unit 66 determines the type of each subject and selects, as the main subject, the subject that matches a type set by the user using the operation unit 16. For example, in a case where a person imaging mode is set, the feature extraction unit 66 selects, as the main subject, a person from the plurality of subjects appearing in the frame.

Further, the feature extraction unit 66 can also select the main subject based on positions, within an angle of view, of the plurality of subjects appearing in the frame. In this case, for example, the feature extraction unit 66 obtains the position of each subject within the angle of view, and selects the subject located at a center of the angle of view as the main subject.

Further, the feature extraction unit 66 can also select the main subject based on a focusing position of the imaging lens 12. In this case, for example, the feature extraction unit 66 acquires information related to the focusing position from the main controller 60, and selects, as the main subject, the subject closest to the focusing position from the plurality of subjects appearing in the frame.

Further, the feature extraction unit 66 can also select the main subject based on input information of the user. In this case, for example, the feature extraction unit 66 selects, as the main subject, the subject located in the subject area, which is selected by the user using the operation unit 16. The feature extraction unit 66 may select, as the main subject, the subject located at the AF area automatically detected by the imaging apparatus 10.

Further, the feature extraction unit 66 can also select the main subject based on visual line information of the user. In this case, for example, the imaging apparatus 10 has a function of detecting a visual line of the user who looks through the finder 14. The feature extraction unit 66 acquires the visual line information of the user and selects, as the main subject, the subject present at a position of the visual line within the angle of view.

Further, the feature extraction unit 66 may recognize an imaging scene based on the video data PD, and may use the recognized imaging scene as the feature of the video data PD. The imaging scene can be performed using a machine-trained model. For example, in a case where the imaging scene is a scene in which a generated sound is assumed to be high in volume, such as “sports”, the volume range setting unit 63 sets the volume range VR to the high volume side. On the other hand, in a case where the imaging scene is a scene in which a generated sound is assumed to be low in volume, such as “night view”, the volume range setting unit 63 sets the volume range VR to the low volume side. The feature extraction unit 66 may use the imaging scene set by the user using the operation unit 16 as the feature of the video data PD.

### Second Modification Example

In the above embodiment, the volume range setting unit 63 sets the volume range VR based on the feature of the video data PD, which is extracted by the feature extraction unit 66, but the volume range VR may be set based on an imaging condition under which the subject is imaged. In this case, for example, the volume range setting unit 63 sets the volume range VR based on the imaging condition such as an exposure value set by the main controller 60. For example, in a case where the exposure value is small, the volume range setting unit 63 sets the volume range VR to the high volume side. On the other hand, in a case where the exposure value is large, the volume range setting unit 63 sets the volume range VR to the low volume side.

Further, in a case where the imaging apparatus 10 has an optical zoom function or an electronic zoom function, the volume range setting unit 63 may set the volume range VR based on a zoom magnification as the imaging condition. For example, in a case where the zoom magnification is small (that is, in case of wide angle of view), the main subject is assumed to be present nearby and the sound generated by the main subject is assumed to be high in volume. Thus, the volume range setting unit 63 sets the volume range VR to the high volume side. On the other hand, in a case where the zoom magnification is large (that is, in case of telephoto), the main subject is assumed to be present at a distance and the sound generated by the main subject is assumed to be low in volume. Thus, the volume range setting unit 63 sets the volume range VR to the low volume side.

### Third Modification Example

In the above embodiment, the video file creation unit 65 creates the video file 28 including the video data PD and the third sound data AS3, but may create the video file 28 including the second sound data AS2 or the second sound data AS2F and the video data PD instead of the third sound data AS3. Hereinafter, the video file 28 including the video data PD and the third sound data AS3 is referred to as a first video file 28A, and the video file 28 including the second sound data AS2 or the second sound data AS2F and the video data PD is referred to as a second video file 28B. In the present modification example, the video file 28 including the second sound data AS2F and the video data PD is referred to as the second video file 28B.

In the present modification example, the imaging apparatus 10 has a first mode of creating the first video file 28A and a second mode of creating the second video file 28B. The second sound data AS2F has a large dynamic range. Thus, in a case where the volume width of the sound signal AS output from the external microphone 13 exceeds the dynamic range of the third sound data AS3, the second mode is preferably executed instead of the first mode. In the present modification example, the second mode is executed or the execution of the second mode is recommended, based on volume information of the sound signal AS.

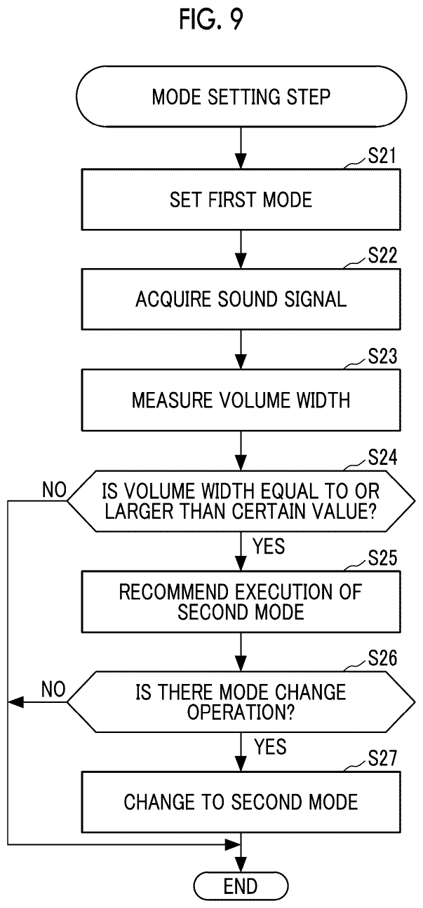

FIG. 9 is a flowchart showing an example of a mode setting step according to a third modification example. In the present modification example, the main controller 60 executes the mode setting step in an imaging preparation stage before the execution of the imaging operation.

In the mode setting step, first, the main controller 60 sets a creation mode to the first mode (step S21). Next, the main controller 60 acquires the analog sound signal AS from the external microphone 13 (step S22). The main controller 60 measures the volume width, which is an example of the volume information, based on the acquired sound signal AS (step S23).

The main controller 60 determines whether or not the measured volume width is equal to or larger than a certain value (step S24). In a case where the measured volume width is equal to or larger than the certain value (YES in step S24), the main controller 60 causes the display 15 to display a message to recommend the execution of the second mode (step S25). In a case where the user desires to change the mode based on the message displayed on the display 15, the user can change the creation mode to the second mode using the operation unit 16.

The main controller 60 determines whether or not there is a mode change operation by the user (step S26). In a case where the mode change operation is performed (YES in step S26), the main controller 60 changes the creation mode to the second mode (step S27).

In a case where the volume width is less than the certain value (NO in step S24) or in a case where the mode change operation is not performed (NO in step S26), the main controller 60 ends the processing without changing the creation mode from the first mode. The mode setting step is ended as described above.

In a case where the creation mode is the first mode, the imaging operation of the imaging apparatus 10 is the same as that in the above embodiment, and the first video file 28A is created in the third creation step (step S17) shown in FIG. 8. On the other hand, in a case where the creation mode is the second mode, the second video file 28B is created in the third creation step. In a case where the creation mode is the second mode, there is no need to create the third sound data AS3, and thus the setting step (step S14) and the second creation step (step S15) shown in FIG. 8 do not need to be executed.

In the present modification example, in a case where the volume width is equal to or larger than the certain value, the step of recommending the execution of the second mode is executed. In a case where the mode change operation is performed, the creation mode is changed to the second mode. Instead of the above, in a case where the volume width is equal to or larger than the certain value, the creation mode may be changed to the second mode (that is, the second mode may be executed) without executing the step of recommending the execution of the second mode.

### Fourth Modification Example

In the above embodiment, the amplifier 42 performs the gain processing on the sound signal output from the sound collection element 41 in the external microphone 13, but the gain amount of the gain processing by the amplifier 42 may be further changed based on the volume information of the sound signal AS output from the external microphone 13.

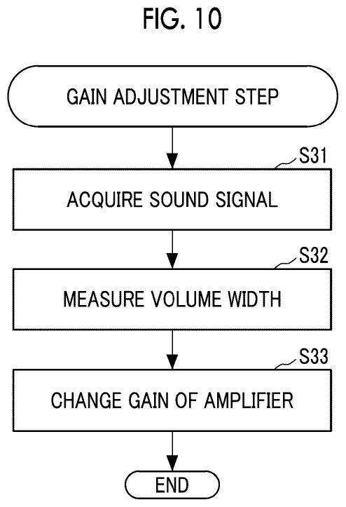

FIG. 10 is a flowchart showing an example of a gain adjustment step according to a fourth modification example. In the present modification example, the main controller 60 executes the gain adjustment step in the imaging preparation stage before the execution of the imaging operation.

In the gain adjustment step, first, the main controller 60 acquires the analog sound signal AS from the external microphone 13 (step S31). Next, the main controller 60 measures the volume width, which is an example of the volume information, based on the acquired sound signal AS (step S32). The main controller 60 changes the gain amount of the amplifier 42 via the microphone control unit 43, based on the measured volume width (step S33). Accordingly, it is possible to set the volume of the sound signal AS input to the sound signal processing circuit 23 to an appropriate width in advance.

The main controller 60 may change the gain amount of the amplifier 42, based on the volume information determined from the feature of the subject or priority information of a sound source to be recorded. For example, in a case where the volume of the sound generated by the subject is determined to be small, the main controller 60 increases the gain amount based on the feature of the subject. Further, for example, the main controller 60 determines, from the focusing position of the imaging lens 12 or the like, the subject required to be prioritized, and estimates the sound of the subject with a high priority to set an optimal gain amount.

### Fifth Modification Example

In the above embodiment, the sound signal AS input from the external microphone 13 to the sound signal processing circuit 23 is the analog signal, and is converted into the digital signal inside the sound signal processing circuit 23. Instead of the above, the sound signal AS may be converted into the digital signal inside the external microphone 13, and then the digital sound signal AS may be transmitted to the sound signal processing circuit 23 via the connecting part 11B.

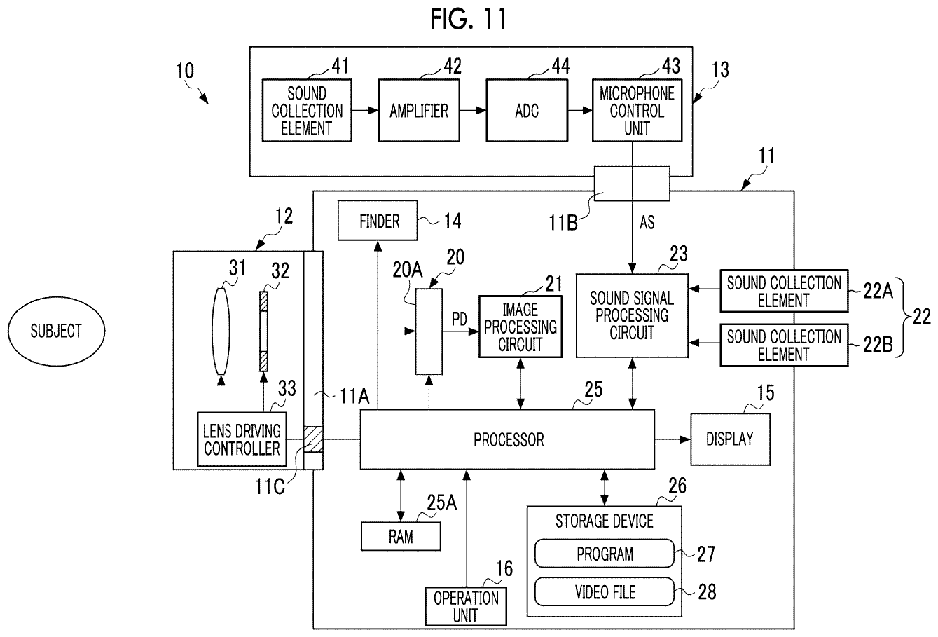

FIG. 11 shows a configuration of the imaging apparatus 10 according to a fifth modification example. In the present modification example, an ADC 44 is provided inside the external microphone 13. The ADC 44 performs the A/D conversion on the sound signal subjected to the gain processing by the amplifier 42 to generate the digital sound signal AS. The microphone control unit 43 transmits the digital sound signal AS to the sound signal processing circuit 23 via the connecting part 11B. The sound signal AS is, for example, the digital signal of the 24-bit LPCM format. In the present modification example, there is no need to perform the A/D conversion on the sound signal AS inside the sound signal processing circuit 23.

### Other Modification Examples

In the above embodiment, the third sound data AS3 is sound data of a monaural format that does not have directivity information, but the third sound data AS3 may be sound data of a stereo format that has the directivity information. For example, the directivity information can be generated by using the sound signal acquired by the built-in microphone 22 that is the stereo microphone.

The technique of the present disclosure is not limited to the digital camera and can also be employed for electronic devices such as a smartphone and a tablet terminal having an imaging function.

In the above embodiment, various processors to be described below can be used as the hardware structure of the control unit with the processor 25 as an example. The above various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured by one of these various processors or a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured as one processor can be considered. As a first example, there is an aspect in which one or more CPUs and software are combined to configure one processor and the processor functions as a plurality of control units, as represented by a computer such as a client and a server. As a second example, there is an aspect in which a processor that implements the functions of the entire system, which includes a plurality of control units, with one IC chip is used, as represented by system on chip (SOC). In this manner, the control unit can be configured by using one or more of the above various processors as the hardware structure.

Furthermore, more specifically, it is possible to use an electrical circuit in which circuit elements such as semiconductor elements are combined, as the hardware structure of these various processors.

The above embodiment and respective modification examples can be combined as appropriate as long as there is no contradiction.

Contents described and illustrated above are for detailed description of a portion according to the technique of the present disclosure and are only an example of the technique of the present disclosure. For example, the descriptions regarding the configurations, the functions, the actions, and the effects are descriptions regarding an example of the configurations, the functions, the actions, and the effects of the part according to the technique of the present disclosure. Accordingly, in the contents described and the contents shown hereinabove, it is needless to say that removal of an unnecessary part, or addition or replacement of a new element may be employed within a range not departing from the gist of the present technique of the present disclosure. Furthermore, to avoid confusion and to facilitate understanding of a part according to the technique of the present disclosure, description relating to common technical knowledge and the like that does not require particular description to enable implementation of the technique of the present disclosure is omitted from the content of the above description and from the content of the drawings.

In a case where all of documents, patent applications, and technical standard described in the specification are built into the specification as references, to the same degree as a case where the incorporation of each of documents, patent applications, and technical standard as references is specifically and individually noted.

The following technique can be understood from the above description.

### Supplementary Note 1

An imaging method comprising:
an acquisition step of acquiring first sound data having a first number of bits, which is generated based on a sound signal output from a sound collection element and corresponds to video data obtained by imaging a subject; and
a first creation step of creating second sound data having a second number of bits, which is larger than the first number of bits, based on the first sound data.

### Supplementary Note 2

The imaging method according to Supplementary Note 1,
wherein the video data is moving image data.

### Supplementary Note 3

The imaging method according to Supplementary Note 1 or 2, further comprising:
a second creation step of creating third sound data having a third number of bits, which is smaller than the second number of bits, based on the second sound data; and
a third creation step of creating a first video file including the video data and the third sound data.

### Supplementary Note 4

The imaging method according to Supplementary Note 3,
wherein, in the second creation step, data of a volume range having a width of the third number of bits is extracted to create the third sound data, based on the second sound data.

### Supplementary Note 5

The imaging method according to supplementary note 4, further comprising:
a setting step of setting the volume range for the second sound data for each predetermined time before the second creation step is executed.

### Supplementary Note 6

The imaging method according to Supplementary Note 5,
wherein, in the setting step, the volume range is set based on a feature of the video data or an imaging condition.

### Supplementary Note 7

The imaging method according to supplementary note 5,
wherein, in the setting step, the volume range is set based on a feature of a main subject appearing in a frame constituting the video data.

### Supplementary Note 8

The imaging method according to Supplementary Note 7,
wherein, in the setting step, the main subject is selected from a plurality of subjects appearing in the frame, based on a size or a type of the subject in the frame, a position of the subject within an angle of view, a focusing position of an imaging lens that images the subject, input information of a user, or visual line information of the user.

### Supplementary Note 9

The imaging method according to any one of Supplementary Notes 1 to 8,
wherein, in the first creation step, the first sound data generated by performing first gain processing on the sound signal is combined with the first sound data generated by performing second gain processing, which has a different gain amount from the first gain processing, on the sound signal, to create the second sound data.

### Supplementary Note 10

The imaging method according to any one of Supplementary Notes 1 to 9,
wherein the second sound data is in a floating point format.

### Supplementary Note 11

The imaging method according to any one of Supplementary Notes 3 to 8,
wherein a first mode of creating the first video file and a second mode of creating a second video file including the video data and the second sound data are included,
the imaging method further comprises:
   a step of recommending an execution of the second mode or a step of executing the second mode, based on volume information of the sound signal output from the sound collection element or volume information determined from a feature of the video data.

### Supplementary Note 12

The imaging method according to any one of Supplementary Notes 1 to 11, further comprising:
a gain adjustment step of performing gain processing on the sound signal,
wherein, in the gain adjustment step, a gain amount of the gain processing is changed, based on volume information of a sound collected by the sound collection element, volume information determined from a feature of the subject, or priority information of a sound source to be recorded.

What is claimed is:

1. An imaging method comprising:
an acquisition step of acquiring first sound data having a first number of bits, which is generated based on a sound signal output from a sound collection element and corresponds to video data obtained by imaging a subject; and
a first creation step of creating second sound data having a second number of bits, which is larger than the first number of bits, based on the first sound data.

2. The imaging method according to claim 1,
wherein the video data is moving image data.

3. The imaging method according to claim 1, further comprising:
a second creation step of creating third sound data having a third number of bits, which is smaller than the second number of bits, based on the second sound data; and
a third creation step of creating a first video file including the video data and the third sound data.

4. The imaging method according to claim 3,
wherein, in the second creation step, data of a volume range having a width of the third number of bits is extracted to create the third sound data, based on the second sound data.

5. The imaging method according to claim 4, further comprising:
a setting step of setting the volume range for the second sound data for each predetermined time before the second creation step is executed.

6. The imaging method according to claim 5,
wherein, in the setting step, the volume range is set based on a feature of the video data or an imaging condition.

7. The imaging method according to claim 5,
wherein, in the setting step, the volume range is set based on a feature of a main subject appearing in a frame constituting the video data.

8. The imaging method according to claim 7,
wherein, in the setting step, the main subject is selected from a plurality of subjects appearing in the frame, based on a size or a type of the subject in the frame, a position of the subject within an angle of view, a focusing position of an imaging lens that images the subject, input information of a user, or visual line information of the user.

9. The imaging method according to claim 1,
wherein, in the first creation step, the first sound data generated by performing first gain processing on the sound signal is combined with the first sound data generated by performing second gain processing, which has a different gain amount from the first gain processing, on the sound signal, to create the second sound data.

10. The imaging method according to claim 1,
wherein the second sound data is in a floating point format.

11. The imaging method according to claim 3,
wherein a first mode of creating the first video file and a second mode of creating a second video file including the video data and the second sound data are included,
the imaging method further comprises:
a step of recommending an execution of the second mode or a step of executing the second mode, based on volume information of the sound signal output from the sound collection element or volume information determined from a feature of the video data.

12. The imaging method according to claim 1, further comprising:
a gain adjustment step of performing gain processing on the sound signal,
wherein, in the gain adjustment step, a gain amount of the gain processing is changed, based on volume information of a sound collected by the sound collection element, volume information determined from a feature of the subject, or priority information of a sound source to be recorded.

13. An imaging apparatus comprising:
an imaging element that images a subject to generate video data; and
a processor configured to
acquire first sound data having a first number of bits, which is generated based on a sound signal output from a sound collection element and corresponds to the video data, and
create second sound data having a second number of bits, which is larger than the first number of bits, based on the first sound data.

14. The imaging apparatus according to claim 13, further comprising:
a housing that accommodates the imaging element and the processor; and
a connecting part that connects an external microphone including the sound collection element to the housing.

15. The imaging apparatus according to claim 14,
wherein the sound signal is converted into a digital signal inside the external microphone and then transmitted into the housing via the connecting part.
